(19) United States
(12) Patent Application Publication
(10) Pub. No.: US 2014/0037846 A1
(43) Pub. Date: Feb. 6, 2014

(54) ENHANCING DEPOSITION PROCESS BY HEATING PRECURSOR

(71) Applicant: Synos Technology, Inc., Fremont, CA (US)

(72) Inventors: Sang In Lee, Sunnyvale, CA (US); Il Song Lee, San Jose, CA (US)

(21) Appl. No.: 13/943,523

(22) Filed: Jul. 16, 2013

Related U.S. Application Data
(60) Provisional application No. 61/678,428, filed on Aug. 1, 2012.

(51) Int. Cl. B05C 3/00; B05D 1/00

(52) U.S. Cl. CPC B05C 3/005; B05D 1/00
USPC 427/255.28; 118/724; 427/255.5

(57) ABSTRACT

Heating of precursor before exposing the substrate to the precursor for depositing material on the substrate using a deposition method (e.g., ALD, MLD or CVD). A reactor for injecting precursor onto the substrate includes a heater placed in a path between a channel connected to a source of the precursor and a reaction chamber of the reactor. As the precursor passes the heater, the precursor is heated to a temperature conducive to the deposition process. Alternatively or in addition to the heater, the reactor may inject a heated gas that mixes with the precursor to increase the temperature of the precursor before exposing the substrate to the precursor.

### CROSS-REFERENCE TO RELATED APPLICATION

This application claims priority under 35 U.S.C. §119(e) to co-pending U.S. Provisional Patent Application No. 61/678,428 filed on Aug. 1, 2012, which is incorporated by reference herein in its entirety.

### BACKGROUND

1. Field of Art

The disclosure relates to depositing one or more layers of materials on a substrate by using atomic layer deposition (ALD) or other deposition methods, and more particularly to heating source precursor or reactant precursor to deposit materials more effectively.

2. Description of the Related Art

Various chemical processes are used to deposit one or more layers of material on a substrate. Such chemical processes include, among others, chemical vapor deposition (CVD), atomic layer deposition (ALD) and molecular layer deposition (MLD). CVD is the most common method for depositing a layer of material on a substrate. In CVD, reactive gas precursors are mixed and then delivered to a reaction chamber where a layer of material is deposited after the mixed gas comes into contact with the substrate.

ALD is another way of depositing material on a substrate. ALD uses the bonding force of a chemisorbed molecule that is different from the bonding force of a physisorbed molecule. In ALD, source precursor is absorbed into the surface of a substrate and then purged with an inert gas. As a result, physisorbed molecules of the source precursor (bonded by the Van der Waals force) are desorbed from the substrate. However, chemisorbed molecules of the source precursor are covalently bonded, and hence, these molecules are strongly adsorbed in the substrate and not desorbed from the substrate. The chemisorbed molecules of the source precursor (adsorbed on the substrate) react with and/or are replaced by molecules of reactant precursor. Then, the excessive precursor or physisorbed molecules are removed by injecting the purge gas and/or pumping the chamber, obtaining a final atomic layer.

MLD is a thin film deposition method similar to ALD but in MLD, molecules are deposited onto the substrate as a unit to form polymeric films on a substrate. In MLD, a molecular fragment is deposited during each reaction cycle. The precursors for MLD have typically been homobifunctional reactants. MLD method is used generally for growing organic polymers such as polyamides on the substrate. The precursors for MLD and ALD may also be used to grow hybrid organic-inorganic polymers such as Alucone (i.e., aluminum alkoxide polymer having carbon-containing backbones obtained by reacting trimethylaluminum (TMA: Al(CH₃)₃) and ethylene glycol) or Zircone (hybrid organic-inorganic systems based on the reaction between zirconium precursor (such as zirconium t-butoxide Zr[OC(CH₃)₃)]₄, or tetrakis(dimethylamido)zieconium Zr[N(CH₃)₂]₄) with diol (such as ethylene glycol)).

During these deposition methods, the substrate is heated to a high temperature to facilitate and enhance the deposition process. In a lower temperature, the reactiveness of precursor is inadequate, and hence, the material deposited on the surface of the substrate as result of exposing the surface to the precursor tend to exhibit inferior properties. However, heating the substrate to a high temperature requires a large amount of energy, and slows down the overall depositing process.

### SUMMARY

Embodiments relate to heating precursor before exposing a substrate to the precursor to increase the reactiveness of the precursor or enhance the properties of material deposited on the substrate. A reactor for injecting precursor is equipped with a heater to increase the temperature of the precursor. The increased temperature of the precursor increases the reactiveness of the precursor even when the substrate is maintained at a lower temperature.

In one embodiment, the reactor includes a body and the heater. The body is formed with a channel, a reaction chamber, an exhaust portion and a constriction zone. The channel carries the gas to the reaction chamber. The reaction chamber is filled with the gas provided by the channel. The exhaust portion discharges the gas from the reactor. The constriction zone is placed between the reaction chamber and the exhaust portion, and forms a passage that is narrower than the reaction chamber. The substrate passing by the reaction chamber is exposed to the gas in the reaction chamber. The heater is placed between the channel and the reaction chamber to heat the gas to a predetermined range of temperature.

In one embodiment, the predetermined range of temperature is higher than a temperature of the substrate while the substrate is passing by the reaction chamber.

In one embodiment, the heater includes a heating element, an enclosure surrounding the heating element, and an outer casing that forms a passage for the gas in conjunction with the enclosure.

In one embodiment, the heater is attached to the body, and an outer surface of the heater forms the reaction chamber.

In one embodiment, the constriction zone is provided above the substrate and is configured to remove excess gas molecules from a surface of the substrate.

In one embodiment, the gas in conjunction with another gas injected onto the substrate forms a layer of material by atomic layer deposition (ALD).

In one embodiment, the body is formed with another channel for carrying another gas to another reaction chamber formed in the body. The other gas is heated by mixing with the gas before the other gas is discharged through the exhaust portion.

In one embodiment, the other gas is disassociated on the substrate by mixing and heating by the other gas.

In one embodiment, the other gas is a purge gas for removing excess gas molecules from the substrate.

### BRIEF DESCRIPTION OF DRAWINGS

FIG. 1 is a cross sectional diagram of a linear deposition device, according to one embodiment.

FIG. 2 is a perspective view of a linear deposition device, according to one embodiment.

FIG. 3 is a perspective view of a rotating deposition device, according to one embodiment.

FIG. 4 is a perspective view of reactors in a deposition device, according to one embodiment.

FIG. 5A is a cross sectional diagram illustrating a reactor taken along line A-B of FIG. 4, according to one embodiment.

FIG. 5B is a bottom view of the reactor of FIG. 5A, according to one embodiment.

FIG. 6 is a cross sectional diagram of a heater according to one embodiment.

FIG. 7 is a cross sectional diagram of a reactor for indirectly heating precursor by mixing the precursor with a heated gas, according to another embodiment.

FIG. 8 is a flowchart illustrating the process of injecting precursor heated by passing the precursor through a heater, according to another embodiment.

FIG. 9 is a flowchart illustrating the process of injecting precursor heated by mixing the precursor with a heated gas, according to one embodiment.

### DETAILED DESCRIPTION OF EMBODIMENTS

Embodiments are described herein with reference to the accompanying drawings. Principles disclosed herein may, however, be embodied in many different forms and should not be construed as being limited to the embodiments set forth herein. In the description, details of well-known features and techniques may be omitted to avoid unnecessarily obscuring the features of the embodiments.

In the drawings, like reference numerals in the drawings denote like elements. The shape, size and regions, and the like, of the drawing may be exaggerated for clarity.

Embodiments relate to heating precursor before exposing the substrate to the precursor for depositing material on the substrate using a deposition method (e.g., ALD, MLD or CVD). A reactor for injecting precursor onto the substrate includes a heater placed in a path between a channel connected to a source of the precursor and a reaction chamber of the reactor. As the precursor passes the heater, the precursor is heated to a temperature conducive to the deposition process. Alternatively or in addition to the heater, the reactor may inject a heated gas that mixes with the precursor to increase the temperature of the precursor before exposing the substrate to the precursor.

In order to heat a substrate to a temperature adequate for depositing a material, a large amount of energy is needed. Further, a complicated sealing structure of the depositing device is needed to prevent heat from escaping from a process chamber that encloses the substrate. Embodiments related to obviating or reducing the heating of substrate by injecting heated precursor onto the substrate.

### EXAMPLE APPARATUS FOR PERFORMING DEPOSITION

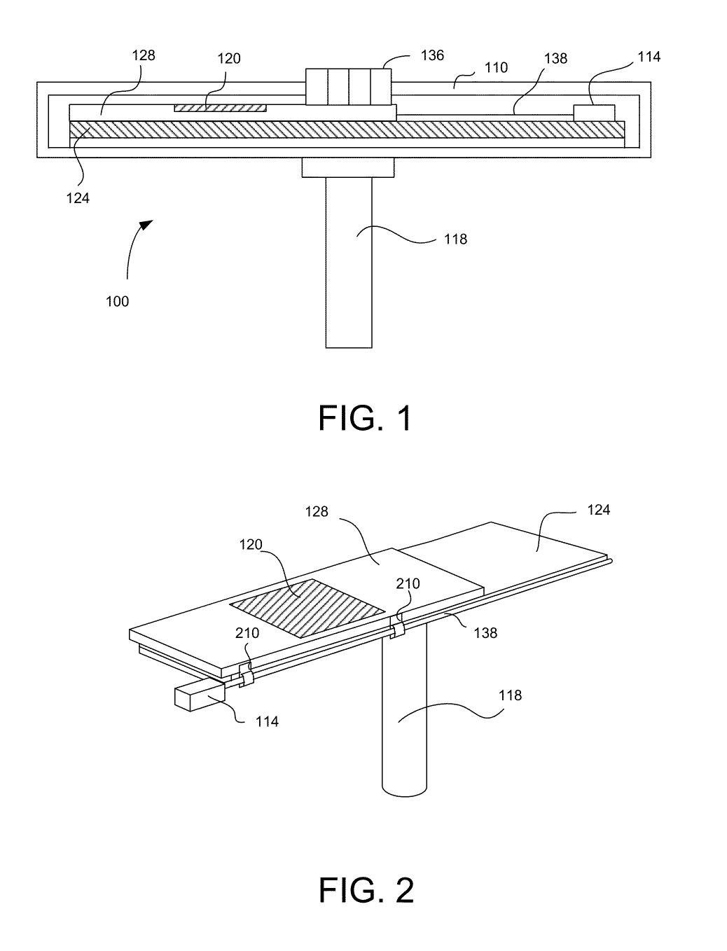

FIG. 1 is a cross sectional diagram of a linear deposition device 100, according to one embodiment. FIG. 2 is a perspective view of the linear deposition device 100 (without chamber walls to facilitate explanation), according to one embodiment. The linear deposition device 100 may include, among other components, a support pillar 118, the process chamber 110 and one or more reactors 136. The reactors 136 may include one or more of injectors and radical reactors for performing MLD, ALD and/or CVD. Each of the injectors injects source precursors, reactant precursors, purge gases or a combination of these materials onto the substrate 120. The gap between the injector and the substrate 120 may be 0.5 mm to 1.5 mm.

The process chamber enclosed by walls may be maintained in a vacuum state to prevent contaminants from affecting the deposition process. The process chamber 110 contains a susceptor 128 which receives a substrate 120. The susceptor 128 is placed on a support plate 124 for a sliding movement. The support plate 124 may include a temperature controller (e.g., a heater or a cooler) to control the temperature of the substrate 120. Conventionally, the substrate 120 is heated to a temperature of over 250° C., sometimes over 500° C. depending on the precursor being used and the material being deposited on the substrate 120. However, embodiments enable the temperature of the substrate 120 to be maintained at a lower temperature by instead heat the precursor to achieve equivalent result of heating the substrate 120.

The linear deposition device 100 may also include lift pins (not shown) that facilitate loading of the substrate 120 onto the susceptor 128 or dismounting of the substrate 120 from the susceptor 128.

In one embodiment, the susceptor 128 is secured to brackets 210 that move across an extended bar 138 with screws formed thereon. The brackets 210 have corresponding screws formed in their holes receiving the extended bar 138. The extended bar 138 is secured to a spindle of a motor 114, and hence, the extended bar 138 rotates as the spindle of the motor 114 rotates. The rotation of the extended bar 138 causes the brackets 210 (and therefore the susceptor 128) to make a linear movement on the support plate 124. By controlling the speed and rotation direction of the motor 114, the speed and the direction of the linear movement of the susceptor 128 can be controlled. The use of a motor 114 and the extended bar 138 is merely an example of a mechanism for moving the susceptor 128. Various other ways of moving the susceptor 128 (e.g., use of gears and pinion or a linear motor at the bottom, top or side of the susceptor 128). Moreover, instead of moving the susceptor 128, the susceptor 128 may remain stationary and the reactors 136 may be moved.

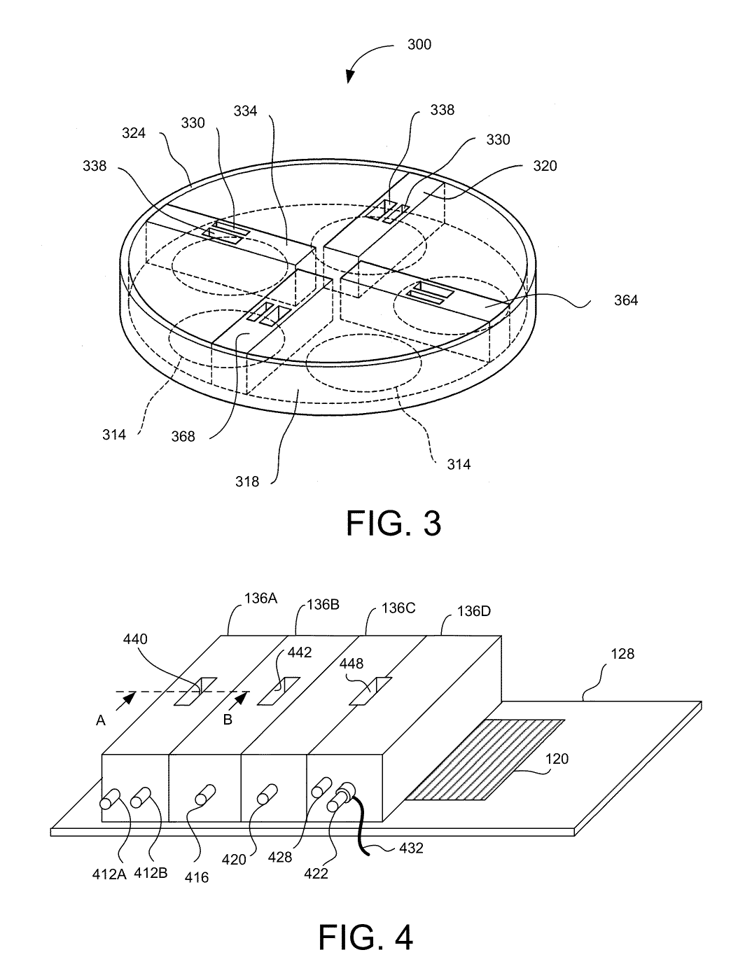

FIG. 3 is a perspective view of a rotating deposition device 300, according to one embodiment. Instead of using the linear deposition device 100 of FIG. 1, the rotating deposition device 300 may be used to perform the deposition process according to another embodiment. The rotating deposition device 300 may include, among other components, reactors 320, 334, 364, 368, a susceptor 318, and a container 324 enclosing these components. A reactor (e.g., 320) of the rotating deposition device 300 corresponds to a reactor 136 of the linear deposition device 100, as described above with reference to FIG. 1. The susceptor 318 secures the substrates 314 in place. The reactors 320, 334, 364, 368 may be placed with a gap of 0.5 mm to 1.5 mm from the substrates 314 and the susceptor 318. Either the susceptor 318 or the reactors 320, 334, 364, 368 rotate to subject the substrates 314 to different processes.

One or more of the reactors 320, 334, 364, 368 are connected to gas pipes (not shown) to provide source precursor, reactor precursor, purge gas and/or other materials. The materials provided by the gas pipes may be (i) injected onto the substrate 314 directly by the reactors 320, 334, 364, 368, (ii) after mixing in a chamber inside the reactors 320, 334, 364, 368, or (iii) after conversion into radicals by plasma generated within the reactors 320, 334, 364, 368. After the materials are injected onto the substrate 314, the redundant materials may be exhausted through outlets 330, 338. The interior of the rotating deposition device 300 may also be maintained in a vacuum state.

The rotating deposition device 300 may also be equipped with one or more heaters to increase the temperature of the substrate 314.

Although following example embodiments are described primarily with reference to the reactors 136 in the linear deposition device 100, the same principle and operation can be applied to the rotating deposition device 300 or other types of deposition device.

FIG. 4 is a perspective view of reactors 136A through 136D (collectively referred to as the “reactors 136”) in the deposition device 100 of FIG. 1, according to one embodiment. The reactors 136A through 136D are placed in tandem adjacent to each other. In other embodiments, the reactors 136A through 136D may be placed with a distance from each other. As the susceptor 128 mounting the substrate 120 moves from the left to the right or from the right to the left, the substrate 120 is sequentially injected with materials or radicals by the reactors 136A through 136D to form a deposition layer on the substrate 120. Instead of moving the substrate 120, the reactors 136A through 136D may move from the right to the left while injecting the source precursor materials or the radicals on the substrate 120.

In one or more embodiments, the reactors 136A, 136B, 136C are gas injectors that inject precursor material, purge gas or a combination thereof onto the substrate 120. Each of the reactors 136A, 136B, 136C is connected to pipes 412A, 412B, 416, 420 to receive precursors, purge gas or a combination thereof from one or more sources. Valves and other pipes may be installed between the pipes 412, 416, 420 and the sources to control the gas and the amount thereof provided to the gas injectors 136A, 136B, 136C. Excess precursor and purge gas molecules are exhausted via exhaust portions 440, 442, 448.

The reactor 136D may be a radical reactor that generates radicals of gas or a gas mixture received from one or more sources. The radicals of gas or gas mixture may function as purge gas, reactant precursor, surface treating agent, or a combination thereof on the substrate 120. The gas or gas mixtures are injected into the reactor 136D via pipe 428, and are converted into radicals within the reactor 136D by applying voltage across electrodes (e.g., electrode 422 and body of the reactor 136C) and generating plasma within a plasma chamber. The electrode 422 is connected via a line 432 to a supply voltage source and the body of the reactor 136, which forms a coaxial capacitive-type plasma reactor, is grounded or connected to the supply voltage source via a conductive line (not shown). The generated radicals are injected onto the substrate 120, and remaining radicals and/or gas reverted to an inactive state from the radicals are discharged from the reactor 136D via the exhaust portion 448. By exposing the substrate 120 to the radicals, the surface of the substrate maintained reactive until the next precursor is injected onto the surface of the substrate.

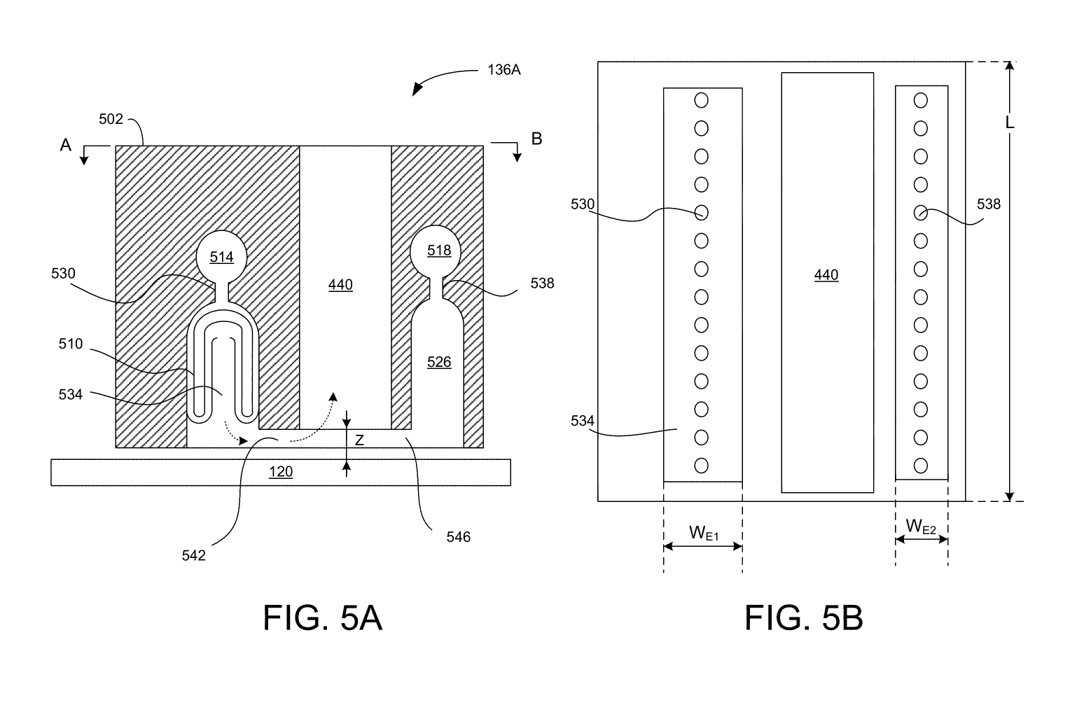

FIG. 5A is a cross sectional diagram illustrating the reactor 136A taken along line A-B of FIG. 4, according to one embodiment. The injector 136A includes, among other components, a heater 510 and a body 502. The body 502 is formed with gas channels 514, 518, perforations (slits or holes) 530, 538, chambers 534, 526, constriction zones 542, 546, and an exhaust portion 440. The gas channel 514 is connected to the pipe 412A to convey precursor into the chamber 534 (having a width Wₑ₁) via the perforations 530 and the heater 510. As the precursor passes through the heater 510, the reactant precursor is heated to a predetermined temperature. The precursor heated in the injector 136A may be source precursor or reactant precursor.

The gas channel 518 is connected to the pipe 412B to convey purge gas (e.g., Argon) into the chamber 526 via the perforations 538. A region of the substrate 120 below the reaction chamber 534 comes into contact with the reactant precursor below the chamber 534 and adsorbs the reactant precursor molecules on its surface.

The excess reactant precursor (i.e., precursor remaining after the reactant precursor is adsorbed on the substrate 120) is at least partially removed from the substrate 120 and is discharged via the exhaust portion 440 as the substrate 20 passes through the constriction zone 542 (having the height of Z). As the precursor passes through the constriction zone 542, the Venturi effect causes the pressure of the precursor to drop and the speed of the precursor to increase in the constriction zone 542. As a result, excess precursor on a portion of the substrate below the constriction zone 542 is at least partly removed from the substrate 120.

In addition, the purge gas is injected into the chamber 526 via the perforations 538, and then discharged to the exhaust portion 440 via the constriction zone 546 (having the height of Z). As the purge gas passes the constriction zone 546, the Venturi effect causes the pressure to drop and the speed of the purge gas to increase. The Venturi effect of the purge gas facilitates further removal of the excess precursor from the surface of the substrate.

FIG. 5B is a bottom view of the reactor 136A of FIG. 5A, according to one embodiment. The reactor 136A has a width of L. The chambers 518A, 518B has width of W_{E1} and W_{E2}, respectively.

The structure of the reactor 136A of FIG. 5A is merely illustrative. Various modifications can be made to the reactor 136A such as removing the pathways and cavity (e.g., gas channel 518, perforations 538 and chamber 526) for injecting the purge gas. Also, the reactor can be modified to inject more than two types of gases or to generate and inject radicals.

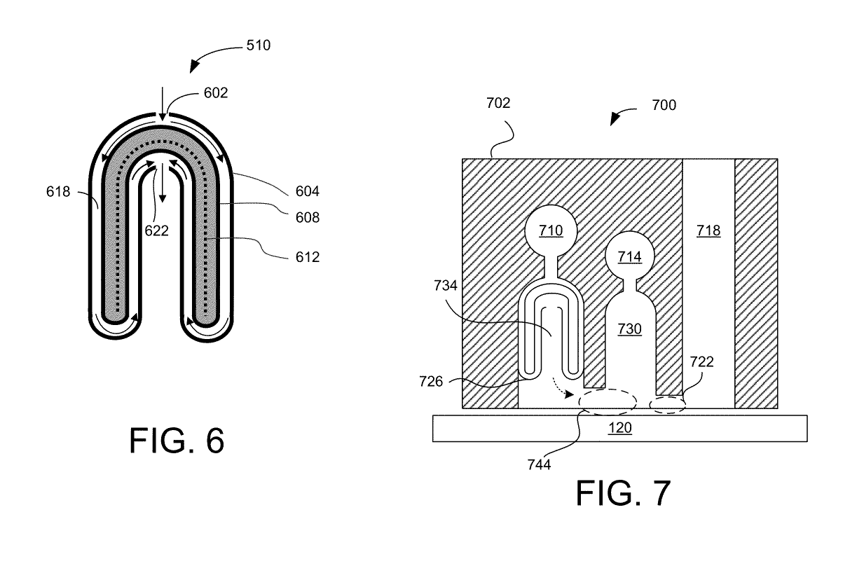

FIG. 6 is a cross section diagram of the heater 510 according to one embodiment. In the embodiment of FIG. 6, the cross section of the heater 510 is horseshoe shaped. The heater 510 may include, among other components, an outer casing 604 and a heating element 612. The heating element 612 may be surrounded by an enclosure 608 made of quartz or other material to prevent the precursor from coming into touch with the heating element 612 and reacting with the heating element 612. In one embodiment, the heating element 612 includes a metal wire through which electric current is applied to heat the heating element 612.

The precursor enters the heater 510 via an entrance 602. As the precursor flows in the clearance 618 between the enclosure 608 and the outer casing 604, the precursor is heated to a predetermined temperature range before being discharged via exit 622 into the reaction chamber 534. In one or more embodiments, the predetermined temperature range is higher than the temperature of the substrate 120.

In one embodiment, the precursor includes one or more of H₂O, O₂, H₂O₂, N₂, O₂ plasma, ozone and organic material.

In one embodiment, the heater 510 extends laterally across the length L of the reactor 136A.

Heating of the precursor as opposed to heating the substrate has, among others, the following advantages; (i) enhancing the properties (e.g., increase in dielectric constant and decreased in leakage current) of the material deposited on the substrate, (ii) promoting formation and maintenance of radicals of the precursor that is more reactive, and (iii) enabling heating of different types of precursor gases to different temperature ranges.

The heater 510 illustrated in FIG. 6 is merely illustrative. Heaters of different shapes and configurations may be placed in the chamber 534 to heat the reactant precursor. The heater may also be placed outside the reactor (e.g., between the pipe 412A and the body 502) instead of within the reactor.

When precursor gas is likely to be disassociated by directly heating the precursor gas, the precursor gas can be indirectly heated by mixing with a heated gas at a region close to the substrate. In this way, the precursor gas is disassociated at or near the surface of the substrate, promoting effective reaction or replacement of the precursor molecules.

FIG. 7 is a sectional diagram of a reactor 700 for indirectly heating precursor by mixing the precursor with a heated gas, according to another embodiment. The reactor 700 may include a heater 726 and a body 702. The body is formed with channel 710 for carrying purge gas, channel 714 for carrying source precursor, chambers 726, 734, and an exhaust portion 718. In reactor 700, the precursor (e.g., reactant precursor or source precursor) is injected into the reaction chamber 730 via the channel 714. There is no separate heater in the path of the precursor to the exhaust portion 718 via constriction zone 722.

Instead of heating the precursor by a heater, the precursor is heated by mixing with a heated gas (e.g., source precursor or purge gas) that passes the channel 710, the heater 726, and the chamber 734 in region 744 around the bottom of the reaction chamber 730. As the gas from the channel 710 passes the heater 726, the precursor injected from the channel 714 is heated to a predetermined temperature range. In one or more embodiments, the predetermined temperature ranges is higher than the temperature of the substrate 120. As the source precursor is heated by mixing with the purge gas in the region 744, the precursor may become disassociated. The disassociated molecules of the precursor then come into contact with the substrate 120 for adsorption on the substrate 120 or reaction with other molecules previously adsorbed on the substrate 120.

The precursor heated in the reactor 700 may be source precursor or reactant precursor for performing atomic layer deposition (ALD). Alternatively, the precursor injected in the reactor 700 may be gas for performing chemical vapor deposition (CVD) or molecular layer deposition (MLD).

In one embodiment, radicals are formed as a result of heating the precursor by mixing with the heated purge gas. The formation of radicals in the vicinity of the substrate advantageously increases the effectiveness of the radicals.

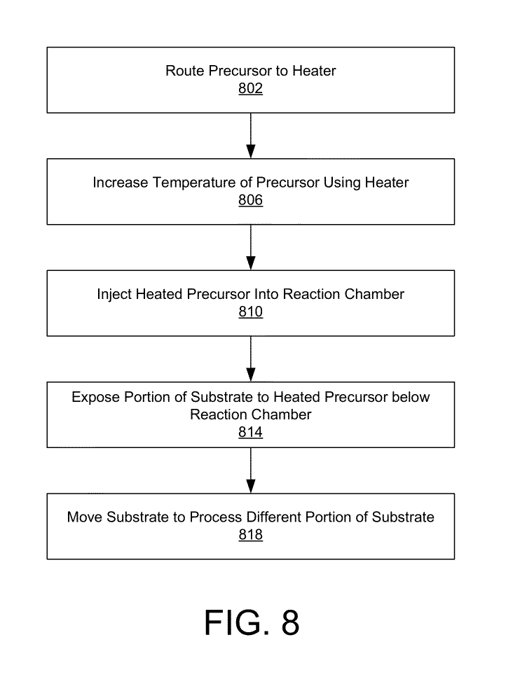

FIG. 8 is a flowchart illustrating the process of injecting precursor heated by a heater, according to another embodiment. Precursor is routed 802 via channel formed in a reactor to a heater. As the precursor passes through the heater, the temperature of the precursor is increased 806 to a predetermined range. The predetermined range may be higher than the temperature of the substrate.

The heated precursor is then injected 810 into a reaction chamber in the reactor. A portion of the substrate below the reaction chamber is exposed 814 to the precursor. If the precursor is source precursor, the source precursor molecules are adsorbed in the substrate. If the precursor is reactant precursor, the precursor molecules react with or replace the source precursor molecules adsorbed on the substrate. The portion of the substrate may be exposed to purge gas to remove excess precursor molecules or excess materials formed as a result of reaction of the precursor molecules.

The substrate is then moved 818 to expose a different portion of the substrate to the heated precursor. The moving of the substrate and the injection of the heated precursor may be repeated to inject the heated precursor to a desired entire region of the substrate. The movement of the substrate and the injection of the heated precursor may be continuous or the movement and the injection may be performed in a discontinuous manner.

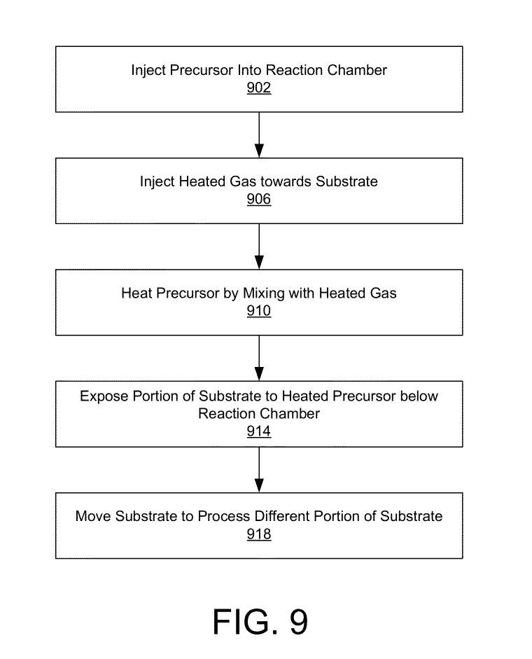

FIG. 9 is a flowchart illustrating the process of injecting precursor heated by mixing with a heated gas, according to one embodiment. The precursor is indirectly heated by a heated gas in this process.

The precursor is injected 902 into a reaction chamber. Another gas travels through a different path compared to the precursor and is injected 906 towards the substrate. The path includes a heater where the gas is heated. In one embodiment, the heated gas is a purge gas. The precursor is then heated 910 to a predetermined range of temperature by mixing with the heated gas.

A portion of the substrate is exposed 914 to the heated precursor (and the heated gas). Then the substrate is moved 918 to expose a different portion of the substrate to the heated precursor. The moving of the substrate and the injection of the heated precursor may be repeated to inject the heated precursor to a desired entire region of the substrate. The movement of the substrate and the injection of the heated precursor may be continuous or the movement and the injection may be performed in a discontinuous manner.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope of this disclosure.

What is claimed is:

1. A reactor for injecting a gas onto a substrate to deposit a material on the substrate, comprising:
a body formed with a channel for carrying the gas, a reaction chamber filled with the gas provided by the channel, an exhaust portion for discharging the gas and a constriction zone between the reaction chamber and the exhaust portion, the constriction zone forming a passage that is narrower than the reaction chamber, the substrate passing by the reaction chamber for exposure to the gas; and
a heater placed between the channel and the reaction chamber to heat the gas to a predetermined range of temperature.

2. The reactor of claim 1, wherein the predetermined range of temperature is higher than a temperature of the substrate while the substrate is passing by the reaction chamber.

3. The reactor of claim 1, wherein the heater comprises a heating element, an enclosure surrounding the heating element, and an outer casing that forms a passage for the gas in conjunction with the enclosure.

4. The reactor of claim 1, wherein the heater attached to the body, and an outer surface of the heater forms the reaction chamber.

5. The reactor of claim 1, wherein the constriction zone is provided above the substrate and is configured to remove excess gas molecules from a surface of the substrate.

6. The reactor of claim 1, wherein the gas in conjunction with another gas injected onto the substrate forms a layer of material by atomic layer deposition (ALD).

7. The reactor of claim 1, wherein the body is formed with another channel for carrying another gas to another reaction chamber formed in the body, the other gas heated by mixing with the gas before the other gas is discharged through the exhaust portion.

8. The reactor of claim 7, wherein the other gas is disassociated on the substrate by mixing and heating by the other gas.

9. The reactor of claim 7, wherein the other gas comprises a purge gas for removing excess gas molecules from the substrate.

10. A method of depositing a material on a substrate, comprising:
routing a gas into a heater in a reactor via a channel formed in the reactor;
increasing a temperature of the gas to a predetermined temperature by the heater;
providing the gas into a reaction chamber in the reactor;
exposing the substrate passing by the reaction chamber to the gas in the reaction chamber; and
discharging gas remaining after exposure to the substrate to an exhaust portion of the reactor via a constriction zone that is narrower than the reaction chamber.

11. The method of claim 10, wherein the predetermined range of temperature is higher than a temperature of the substrate while the substrate is passing by the reaction chamber.

12. The method of claim 10, wherein the heater comprises a heating element, an enclosure surrounding the heating element, and an outer casing that forms a passage for the gas in conjunction with the enclosure.

13. The method of claim 10, wherein the heater attached to the body, and an outer surface of the heater forms the reaction chamber.

14. The method of claim 10, wherein the constriction zone is provided above the substrate and is configured to remove excess gas molecules from a surface of the substrate.

15. The method of claim 10, wherein the gas in conjunction with another gas injected onto the substrate forms a layer of material by atomic layer deposition (ALD).

16. A method of depositing a material on a substrate, comprising:
routing a first gas into a heater in a reactor via a first channel formed in the reactor;
increasing a temperature of the first gas to a predetermined temperature by the heater;
routing a second gas into a reaction chamber in the reactor;
increasing the temperature of the second gas by mixing the first gas and the second gas in the reaction chamber;
exposing the substrate passing by the reaction chamber to the first gas and the second gas in the reaction chamber; and
discharging the first gas and the second gas remaining after exposure to the substrate to an exhaust portion of the reactor via a constriction zone that is narrower than the reaction chamber.

17. The method of claim 16, wherein the second gas is disassociated on the substrate by mixing and heating by the first gas.

18. The method of claim 17, wherein the first gas comprises a purge gas for removing excess gas molecules from the substrate.
